(19) United States
(12) Patent Application Publication
(10) Pub. No.: US 2006/0008110 A1
(43) Pub. Date: Jan. 12, 2006

(54) Receiver with multiple drive coils

(75) Inventor: Aart Zeger van Halteren, Hobrede (NL)

Correspondence Address: FOLEY AND LARDNER LLP;SUITE 500, 3000 K STREET NW, WASHINGTON, DC, 20007, US

(73) Assignee: Sonion Nederland B.V.

(21) Appl. No.: 11/175,039

(22) Filed: Jul. 6, 2005

Related U.S. Application Data
(60) Provisional application No. 60/585,572, filed on Jul. 7, 2004.

(51) Int. Cl. H04R 25/00

(52) U.S. Cl. 381/417; 381/324

(57) ABSTRACT

The invention provides a moving armature receiver, such as for a hearing aid, with at least two drive coils adapted to be driven by separate drive signal across different frequency ranges. This is achieved by a frequency dividing network adapted to split an audio input signal into first and second audio signals of predetermined different frequency ranges. In preferred two drive coil versions the frequency ranges overlap below 2-3 kHz, whether only one of the drive coils is active above 2-3 kHz. The drive coil being active in the upper frequency range has a lower impedance than the other drive coil. Thus, a more suitable effective impedance characteristics can be obtained. This enables an increased maximum acoustic high frequency output and an enhanced high frequency response of the receiver when driven by a low impedance amplifier, such as a class D amplifier. In a preferred embodiment the receiver is adapted to receive a digital audio input signal, the frequency division is performed digitally and two separate digital signals are applied to two separate digital amplifiers each operatively coupled to drive two separate drive coils. The invention also provides a hearing aid output stage adapted to drive a multiple coil moving armature receiver.

### CROSS-REFERENCE TO RELATED PATENT APPLICATIONS

This application claims the benefit under 35 USC 119(e) to U.S. Application 60/585,572, filed Jul. 7, 2004, incorporated herein by reference in its entirety.

### BACKGROUND OF THE INVENTION

The present invention relates to moving armature receivers. More specifically, the invention relates to moving armature receivers adapted to provide a high acoustic output at high frequencies when driven by an amplifier with a low output impedance. In addition, the invention relates to a hearing aid output stage adapted to drive a multiple drive coil moving armature receiver.

Presently, miniatures moving armature loudspeakers, or receivers, for hearing aid use are more and more often applied in voltage-driven applications driven by digital switching amplifiers or class D amplifier such as a digitally modulated PWM or PDM based output amplifier. Such digitally modulated amplifiers have output stage characteristics that typically will drive the moving armature loudspeakers from a very low source impedance, typically 10-50 Ω at audio frequencies, from a pair of differential amplifier terminals at audio frequencies.

A prior art miniature moving armature receiver comprises a single elongate drive coil forming a central tunnel or aperture with a central longitudinal axis. A pair of plane quadratic permanent magnet members is oppositely arranged within a magnet housing so as to form a substantially rectangular air gap there between. The magnet housing is arranged in abutment with the drive coil and positioned in a manner so that a central axis of the rectangular air gap is substantially aligned with the central axis of the drive coil tunnel. A flat U-shaped armature made of a magnetically permeable material comprises a deflectable portion that extends longitudinally and centrally through the drive coil tunnel and the air gap along their common central longitudinal axis.

Since the armature is magnetized by the pair of permanent magnets, an alternating signal current applied to the drive coil will cause a drive force being applied to the armature in a direction substantially perpendicular to the common central longitudinal axis of the drive coil tunnel and the air gap. The movement of the armature causes a corresponding movement of a diaphragm through a drive rod or pin rigidly connected to the armature. The drive coil is electrically connected to a pair of externally accessible drive terminals positioned on a housing of the miniature moving armature receiver. The pair of differential amplifier terminals of the digitally modulated PWM or PDM based output amplifier is accordingly connected to these coil terminals.

Unfortunately, the impedance of a moving armature receiver according to the described prior art single drive coil designs increases rapidly with frequency within the audio frequency range. This increase of impedance is caused by inherent inductive characteristics of the drive coil. A result of this rising impedance curve is that a lower than desired net input electrical power can be supplied to the drive coil in an upper portion of the audio frequency range, i.e. frequencies above about 2000 Hz or 3000 Hz.

The increasing impedance of the moving armature receiver leads to an attenuated acoustical high frequency response under small signal operating conditions and to a less than desired maximum output power capability in the high frequency range. Both of these drawbacks are particularly unfortunate since it should be realised that the vast majority of hearing impaired individuals have the largest hearing loss at high frequencies, and as such the greatest need for amplification and output capability in the upper portion of the audio frequency range to adequately compensate for their respective hearing losses.

EP 1 154 673 A1 describes a hearing aid with a moving armature receiver comprising first and second drive coils fed by first and second electrical signal. The two drive coils serve to solve the problem of adding an analog and a digital electrical signals by magnetical superposition of the respective magnetic fields generated by the first and second drive coils.

GB 2 301 728 A describes a moving armature loudspeaker with two drive coils each connected to separate electrical input terminals. The loudspeaker is intended for use in a headset and the two separate drive coils serve to connect the loudspeaker to two different communication networks, a local network and a command net. The two drive coils may have different impedances, thus allowing both coils to individually match the electrical characteristics of the network to which they are connected.

### SUMMARY OF THE INVENTION

It is an object of the present invention to provide a moving armature receiver suitable for hearing aids. The receiver must be capable of providing a high acoustic output in the upper portion of the audio frequency range.

The object is complied with by providing in a first aspect, a moving armature receiver suitable for a hearing aid, comprising

a housing comprising a sound aperture for delivering an acoustical signal in response to an input signal,

a coil tunnel comprising first and second drive coils,

a deflectable armature comprising an armature portion extending through the coil tunnel, and

frequency dividing means adapted to split the audio input signal into a first audio signal of a first predetermined frequency range for the first drive coil and into a second audio signal of a second predetermined frequency range for the second drive coil.

By driving the receiver using two separate drive coils driven in different frequency ranges of the audio spectrum it is possible to compensate for the rising impedance characteristics towards higher frequencies that a single drive coil exhibits. A moving armature receiver according to the invention is capable of providing a superior maximum output capability and a more suitable response in the upper portion of the audio frequency range.

It is to be understood that the first and second drive coils may be physically positioned in any suitable position relative to each other. In a non-exhaustive list of positions, the first and second drive coils are positioned: behind each other, around each other, and on top of each other. The first and second drive coils may be selected to have either low impedance or high impedance, and if preferred, the first and second drive coils may have different impedances. In preferred embodiments, the first and second drive coils have a DC impedance in the range of 50-500Ω, more preferably in the range of 50-100Ω. Alternatively, the drive coils may have a DC impedance in the range of 1-50 kΩ, more preferably in the range of 1-10 kΩ.

The frequency dividing means may comprise one or more passive components, preferably a capacitor.

The first and second drive coils may be electrically connected in a number of different ways. They may be partly electrically interconnected, or they may be separately electrically connected to the frequency dividing means, more alternatively the frequency dividing means may comprise separate first and second parts adapted for connection to respective first and second drive coils. The first and second drive coils may be connected in cascade between a pair of externally accessible input terminals on the moving armature receiver housing. Alternatively, respective first ends of the first and second drive coils are connected to a common node operatively connected to a first externally accessible input terminal and second ends of the first and second drive coils are connected to a second and third externally accessible input terminals, respectively, so as to form a three terminal receiver. An inductance ratio between the first and second drive coils is between 1 and 5, preferably between 2 and 3.

The receiver may further comprise an amplifier operatively coupled between a receiver input terminal and the frequency dividing means.

The receiver may further comprise an amplifier operatively coupled between an output of the frequency dividing means and the first or the second drive coil.

In a preferred embodiment the receiver comprises:

a first amplifier operatively coupled to a first output of the frequency dividing means to receive the first audio signal and adapted to drive the first drive coil in the first predetermined frequency range, and

a second amplifier operatively coupled to a second output of the frequency dividing means to receive the second audio signal and adapted to drive the second drive coil in the second predetermined frequency range.

The frequency dividing means is preferably adapted to receive and process a digitally coded input signal and generate the first and second audio signals in form of respective digitally coded audio signals and the first and second amplifiers comprise respective digital amplifiers.

Referring to all mentioned embodiments, the frequency dividing means preferably has a crossover frequency between 1 and 5 kHz. The first predetermined frequency range may be limited to substantially extend above the crossover frequency. The second predetermined frequency range may be limited to substantially extend below the crossover frequency.

The frequency dividing means may be adapted to provide the first audio signal of a first frequency range that covers all or most of the operating range of the miniature moving armature receiver such as a frequency range between 100-10 kHz or 200 Hz-8 kHz. According to this embodiment, the second audio frequency signal is applied to the second drive coil across frequencies 1-10 kHz or more preferably 2 kHz-10 kHz or even more preferably 3 kHz-10 kHz. Alternatively, the audio frequency range may be divided into two or more frequency ranges without any substantial overlap. The operating frequency ranges of the drive coils may be split so that the first drive coil is supplied with a drive signal up to about 3 kHz, while the second drive coil is supplied with a drive signal above 3 kHz. The frequency dividing means may control the split of drive voltage or current between the first and second coils and may use roll-off rates of 6 or 12 or 18 dB below and above the crossover frequency.

The receiver may further comprise a third drive coil and frequency dividing means adapted to split the input signal into a third electrical audio signal of a third predetermined audio frequency range for the third drive coil.

Referring to all mentioned embodiments of the first aspect, it is understood that the moving armature receiver is applicable not only for hearing aids but in general for portable communication equipment, including e.g.: mobile phones, in-ear monitors and headsets.

In a second aspect, the invention provides a hearing aid output stage, comprising:

an output stage input terminal adapted to receive a digitally coded input signal,

digital frequency dividing means operatively connected to the output stage input terminal and adapted to split the digitally coded audio signal into first and second audio signals of first and second predetermined frequency ranges, respectively,

a first receiver coil driver operatively connected to a first output of the digital frequency dividing means to receive the first audio signal,

a second receiver coil driver operatively connected to a second output of the digital frequency dividing means to receive the second audio signal.

Thus, the output stage is adapted for connection to respective drive coils of a dual coil moving armature transducer, e.g. a transducer with 3 or 4 external terminals, and thus achieve the advantages mentioned in connection with the first aspect of the invention.

Preferably, the first and second receiver coil drivers comprise a respective pair of differential output terminals.

In a third aspect, the invention provides a portable communication device comprising a moving armature receiver according to the first aspect. The portable communication device may be such as a hearing aid, a mobile phone, an in-ear monitors or a headset. The same advantages and embodiments mentioned above in connection with the first aspect also apply to the third aspect.

In a fourth aspect, the invention provides a hearing aid comprising an output stage according to the second aspect. The same advantages and embodiments mentioned above for the second aspect apply for the fourth aspect.

### BRIEF DESCRIPTION OF THE DRAWINGS

In the following, the invention will be described in detail with reference to the accompanying figures, of which

FIG. 1 shows a schematic diagram of a receiver with two drive coils,

FIG. 2 shows diagrams of two embodiments where frequency dividing between two drive coils is implemented by a capacitor,

FIG. 3 shows a diagram of an embodiment where frequency dividing between three drive coils is implemented by two capacitors,

FIG. 4 shows a diagram of two drive coils with a three terminal connection to a set of differential amplifier outputs.

FIG. 5 shows a schematic diagram of a preferred digital receiver with two drive coils driven by separate digital amplifiers, and

FIG. 6 shows a schematic diagram of a preferred digital output stage adapted to drive a receiver with two drive coils.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE PREFERRED EMBODIMENTS

The moving armature receivers that will be described in the following are especially suited for hearing aid miniature receivers. However, the principles may be applied also within other miniature portable devices, such as headsets.

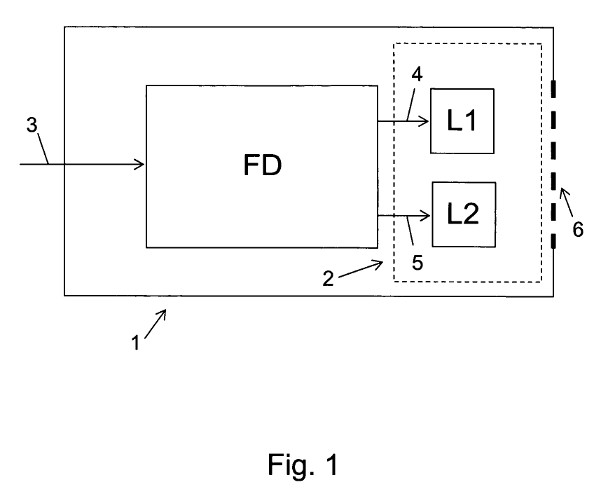

FIG. 1 shows a schematic diagram illustrating basic principles of a moving armature receiver 1 according to the invention. The receiver 1 comprises a moving armature transducer 2 with two drive coils L1 and L2. The receiver 1 is adapted to receive an audio input signal 3 and convert it to an according acoustic output signal via a sound aperture 6. The audio input signal 3 may be provided as an analogue or digitally modulated signal such as PWM or PDM signals wherein the audio signal has been modulated by an ultra-sonic carrier wave. For example, the audio input signal 3 could be a differential output signal from a class D amplifier.

By means of a frequency divider FD the audio input signal 3 is split into a first audio signal 4 of a first frequency range and a second audio signal 5 of a second frequency range. The two resulting audio signals 4, 5 are then fed to the two drive coils L1 and L2, respectively. By proper selection of the first and second audio frequency ranges it is possible to “design” an effective impedance characteristics for the receiver 1 so that it exhibits a frequency characteristics with enhanced response in the upper portion of the audio frequency range than is the case for a single drive coil.

For example the audio input signal 3 may be fed through the frequency divider FD without filtering, so that the first audio signal 4 extends throughout the entire frequency range. The frequency divider FD may then be adapted to highpass filter the audio input signal 3 and provide it as the second audio signal 5. Hereby an effective impedance as seen from the input of the receiver 1 will be the impedance of the first drive coil L1 at low frequencies. In the upper audio frequency range, i.e. in the pass band of the highpass filter of the frequency divider FD, the receiver 1 will exhibit an input impedance being a parallel of both drive coils L1, L2, and thus the effective impedance in the upper audio frequency range becomes lower than for each of the coils L1, L2 separately. As a result the receiver will exhibit an enhanced response in the upper audio frequency range.

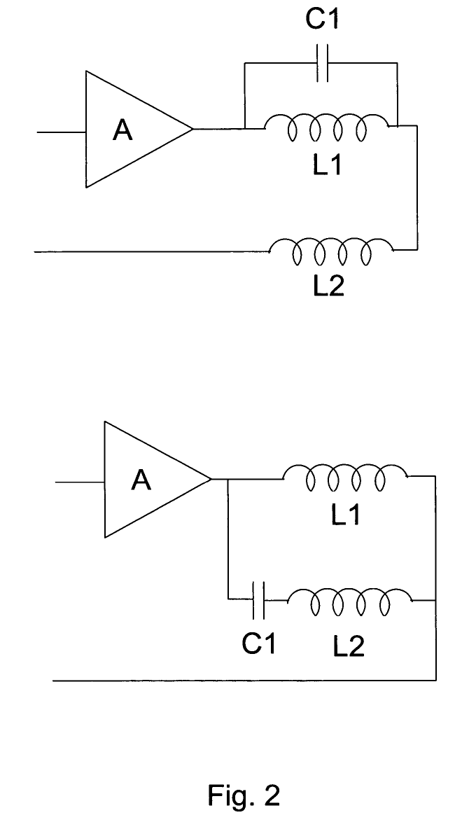

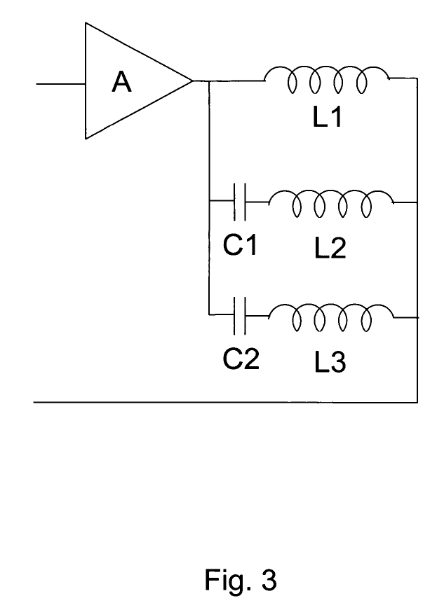

In general the frequency divider FD can be implemented either by passive components or the frequency divider FD can be implemented by active means. In the following FIGS. 2 and 3 illustrate simple passive embodiments.

FIG. 2, upper part, illustrates a diagram of an embodiment with the first L1 and second L2 drive coils arranged in cascade, and a class D amplifier A applies a signal to the drive coils L1, L2. The class D amplifier A may be an analog PWM or PDM type amplifier or a digital PWM or PDM type amplifier. A capacitor C1 operates as the frequency dividing network, and it is connected across the first drive coil L1 to bypass the first coil L1 in the second audio frequency range and supply substantially all drive current to the second coil. The ratio of inductance between the first L1 and the second L2 drive coils is preferably about 2-3.

By suitably selecting the capacitor C1 in accordance with the chosen inductance value of L1, C1 will function as an effective short circuit of the first coil L1 in the upper portion of the audio frequency range. Accordingly, substantially the entire audio signal, i.e. drive voltage of the class D amplifier A, will be applied to the second coil L2 within the second audio frequency range leading to a correspondingly larger drive current through the second drive coil L2 as compared to the situation with a single drive coil.

At low frequencies, i.e. in the first audio frequency range, the bypass capacitor C1 presents a relatively high impedance and the drive current will flow equally through the first L1 and second L2 drive coils which means that the cascade of the first L1 and second L2 drive coils operate as a single coil with an impedance equal to the sum of their individual coil impedances.

FIG. 2, lower part, illustrates a diagram of an embodiment with the first L1 and second L2 drive coils arranged in parallel, and a class D amplifier, of a type as mentioned above, applies a signal to the drive coils L1, L2. By suitably selecting the capacitor C1 that operates as a frequency dividing network, it will function as an effective short circuit in the upper audio frequency range by placing the coils L1, L2 in parallel to lower the total impedance of the receiver. Preferably, the second coil L2 has a much lower inductance than the first coil L1. Thus, the majority of the drive current delivered by the class D amplifier A will flow through the second drive coil. At low audio frequencies, the capacitor C1 will ensure that drive current flows mainly through the first drive coil L1 due to the rising impedance of the capacitor C1.

FIG. 3 shows a diagram of an embodiment illustrating that the general inventive principle of using more that one drive coil can be extended to use many drive coils. In FIG. 3, three drive coils L1, L2, L3 are coupled in parallel. Preferably, L2 has an inductance much higher than L3, and L1 has an inductance higher than L2. L2 is cascaded by a capacitor C1, and L3 is cascaded by another capacitor C2. Following the principles described above, L1 will be active in the entire frequency range, whereas suitable inductance values of L2 and L3 can be combined with suitable values for capacitors C1, C2 so that L2 is active in the frequency range above a first crossover frequency, whereas L3 is active above a second crossover frequency higher than the first crossover frequency. For example first and second crossover frequency of 1 kHz and 5 kHz may be chosen. Thus, FIG. 3 illustrates the general principle that respective frequency dividing networks are used to split the audio drive signal from the class D amplifier A into a number of adjacent frequency bands that each has a dedicated drive coil associated therewith. By using more than two drive coils, such as three, four, five or more drive coils, and a proper selection of drive coil impedances and crossover frequencies an even more suitable resulting impedance curve can be obtained than using two coils.

In a preferred embodiment, a class D amplifier, of a type as mentioned above, is integrated into the miniature moving armature receiver. The class D amplifier is preferably a digital amplifier and adapted for receipt of a digitally formatted audio signal. The class D amplifier comprises a pair of differential output terminals operatively coupled to each end portion of the coil networks shown in FIG. 1.

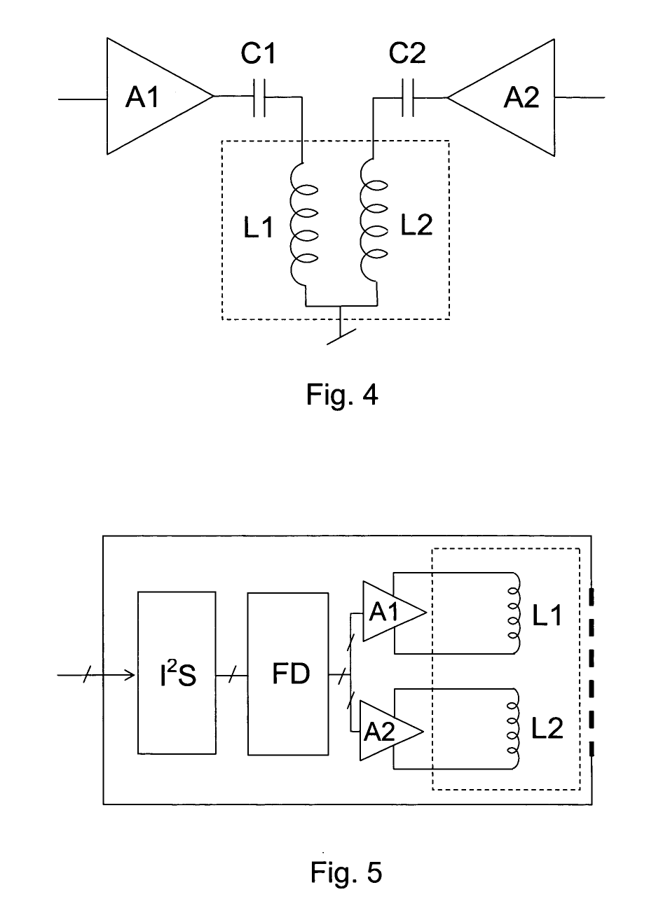

FIG. 4 shows another embodiment of the invention with a class D amplifier having a pair of differential outputs A1, A2 operatively coupled to first L1 and second L2 drive coils. The drive coils L1, L2 are arranged in parallel and each of the drive coils L1, L2 has an associated capacitor C1, C2 in series with it. Each drive coil L1, L2 has one end connected to a common ground terminal. This embodiment requires a three-terminal miniature moving armature receiver in those variants that do not have an integral class D amplifier. Such a three-terminal receiver is illustrated by the dashed box. For applications, that use an amplifier with a pair of oppositely phase drive signals A1, A2, the first L1 and second L2 coils are wound along the coil tunnel in opposite phase to ensure that the drive forces applied to the deflectable armature portion are in-phase.

In FIG. 4 C1 is preferably much larger than C2, and preferably C1 is larger than 1μ. In addition, L1 has an inductance preferably being approximately twice the inductance of L2. As a result, C1 in series with the first drive coil L1 will ensure that the first drive coil L1 receives substantial all drive current from the A1 terminal of the class D amplifier through the entire audio frequency range. Conversely, the smaller capacitor C2 in series with the second drive coil L2 ensures that only an upper audio frequency range portion of the signal drive current delivered by the A2 terminal of the class D amplifier is applied to the second drive coil L2. At audio frequencies where the impedance of capacitor C2 is of about equal value or smaller than the impedance of the second drive coil L2, a main portion of the drive current available to the miniature moving armature receiver will flow through the second coil L2 since the impedance of this coil L2 is lower than the impedance of the first drive coil L1.

FIG. 5 shows a schematic illustration of another preferred embodiment. In FIG. 5, the miniature moving armature receiver comprises two integrally positioned class D amplifiers A1 and A2. A pair of differential output terminals of a first class D amplifier A1 is operatively connected to a the first drive coil L1 and pair of differential output terminals of a second class D amplifier A2 is operatively connected to a the second drive coil L2.

The embodiment of FIG. 5 is illustrated with an active digital frequency dividing network FD that splits the incoming digitally coded input signal into two or more frequency ranges that are applied to a respective digital class D amplifier A1, A2. An advantage of this embodiment is that the previously mentioned components of the frequency dividing network such as capacitors can be entirely omitted since their function is replaced by digital logic that can be integrated together with one or several digital Class D amplifiers on a common CMOS integrated circuit.

However, the frequency dividing network of FIG. 5 could alternatively be implemented as either a passive or an active network or even a combination of both. The passive network may comprise a capacitor in series with the second coil L2 to ensure that the second coil receives substantial drive current solely in the upper audio frequency range, see description in relation to FIG. 2 for further details. The drive first coil L1 may advantageously be driven across the entire audio frequency range by direct connection to the first class D amplifier. In the upper audio frequency range the first L1 and second L2 coils cooperate to apply drive force to the armature.

The receiver embodiment illustrated in FIG. 5 comprises a digital data input section I²S adapted to receive a digitally coded input signal according to a I²S digital audio protocol. Alternatively, a digital data input section may be adapted to receive digital audio signals coded according to a serial data protocol such as IIC, SPI or other digital audio protocols, for example SPDIF.

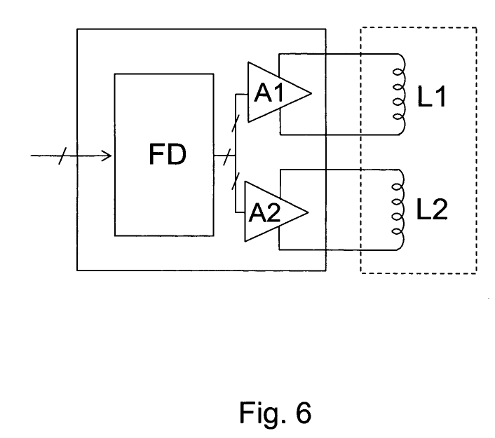

FIG. 6 illustrates a hearing aid output stage, solid box, adapted to drive a hearing aid moving armature receiver, dashed box, with first L1 and second L2 drive coils. Preferably, the output stage is formed integral with the hearing aid circuitry that will normally comprise a DSP (Digital Signal Processor). Thus, the output stage is adapted to receive a digital audio input signal. The output stage comprises a digital frequency divider circuit FD adapted to split the received digital audio input signal into first and second digital audio signals of first and second frequency ranges, respectively. The first and second digital audio signals are fed to digital class D amplifiers A1, A2, respectively. These amplifiers A1, A2 amplify the received first and second digital audio signals and apply first and second amplified audio signals to first and second output terminals of the output stage, respectively. The schematic illustration indicates a four-terminal connection between the output stage and the receiver. However, using the principles illustrated in FIG. 4, a three-terminal version may be implemented.

What is claimed is:

1. A moving armature receiver suitable for a hearing aid, comprising:
a housing including at least a sound aperture for delivering an acoustical signal in response to an input signal,
a coil tunnel including at least first and second drive coils,
a deflectable armature including an armature portion extending through the coil tunnel, and
a frequency divider adapted to split the input signal into a first audio signal of a first predetermined frequency range for the first drive coil and into a second audio signal of a second predetermined frequency range for the second drive coil.

2. A moving armature receiver according to claim 1, wherein the frequency divider includes at least one or more passive components.

3. A moving armature receiver according to claims 2, wherein the passive components comprise a capacitor.

4. A moving armature receiver according to claim 1, wherein the first and second drive coils are connected in cascade between a pair of externally accessible input terminals on the moving armature receiver housing.

5. A moving armature receiver according to claim 1, wherein respective first ends of the first and second drive coils are connected to a common node operatively connected to a first externally accessible input terminal and second ends of the first and second drive coils are connected to a second and third externally accessible input terminals, respectively, so as to form a three terminal receiver.

6. A moving armature receiver according to claim 4, wherein an inductance ratio between the first and second drive coils is between 1 and 5, preferably between 2 and 3.

7. A moving armature receiver according to claim 5, wherein an inductance ratio between the first and second drive coils is between 1 and 5, preferably between 2 and 3.

8. A moving armature receiver according to claim 1, further comprising an amplifier operatively coupled between a receiver input terminal and the frequency divider.

9. A moving armature receiver according to claim 1, further comprising an amplifier operatively coupled between an output of the frequency divider and the first or the second drive coil.

10. A moving armature receiver according to claim 9, comprising
a first amplifier operatively coupled to a first output of the frequency divider to receive the first audio signal and adapted to drive the first drive coil in the first predetermined frequency range, and
a second amplifier operatively coupled to a second output of the frequency divider to receive the second audio signal and adapted to drive the second drive coil in the second predetermined frequency range.

11. A moving armature receiver according to claim 10, wherein the frequency divider is adapted to receive and process a digitally coded input signal and generate the first and second audio signals in form of respective digitally coded audio signals and the first and second amplifiers comprise respective digital amplifiers.

12. A moving armature receiver according to claim 1, wherein the frequency divider has crossover frequency between 1 and 5 kHz.

13. A moving armature receiver according to claim 12, wherein the first predetermined frequency range is limited to substantially extend above the crossover frequency.

14. A moving armature receiver according to claim 13, wherein the second predetermined frequency range is limited to substantially extend below the crossover frequency.

15. A moving armature receiver according to claim 1, further comprising
a third drive coil, and
wherein the frequency divider is adapted to split the input signal into a third electrical audio signal of a third predetermined audio frequency range for the third drive coil.

16. A hearing aid output stage, comprising
an output stage input terminal adapted to receive a digitally coded input signal,
digital frequency divider operatively connected to the output stage input terminal and adapted to split the digitally coded audio signal into first and second audio signals of first and second predetermined frequency ranges, respectively,
a first receiver coil driver operatively connected to a first output of the digital frequency divider to receive the first audio signal,
a second receiver coil driver operatively connected to a second output of the digital frequency divider to receive the second audio signal.

17. A hearing aid output stage according to claim 16, wherein the first and second receiver coil drivers comprise a respective pair of differential output terminals.

18. Portable communication device comprising a moving armature receiver according to claim 1.

19. Hearing aid comprising an output stage according to claim 16.

20. Hearing aid comprising an output stage according to claim 17.
